(19) United States
(12) Patent Application Publication
(10) Pub. No.: US 2025/0067202 A1
(43) Pub. Date: Feb. 27, 2025

(54) ACOUSTIC EFFICIENCY

(71) Applicant: McLaren Automotive Limited, Woking (GB)

(72) Inventors: Alessio Figuretti, Tarragona (ES); Davide Palmieri, Barcelona (ES); Laurence Reucroft, Chertsey (GB)

(21) Appl. No.: 18/810,446

(22) Filed: Aug. 20, 2024

(30) Foreign Application Priority Data
Aug. 21, 2023 (GB) 2312768.1

(51) Int. Cl. F01N 1/16; G10K 11/26

(52) U.S. Cl. CPC F01N 1/165; G10K 11/26

(57) ABSTRACT

A sound bypass device configured to transmit engine-generated sound pulses from an engine to an auditory environment whilst preventing the flow of gases to the auditory environment, the sound bypass device comprising: a chamber enclosing an internal volume between an inlet of the chamber and an outlet of the chamber, the inlet of the chamber being configured to receive gases exiting or entering the engine of the vehicle and the outlet of the chamber being configured to transmit sound pulses to the auditory environment; a first flexible membrane located within the chamber, the first flexible membrane being configured to transmit engine-generated sound pulses from the gases whilst preventing the movement of gases from the inlet of the chamber to the outlet of the chamber; a second flexible membrane that is separated from the first flexible membrane within the chamber; and a hollow spacer coupled to the first flexible membrane at a first end of the spacer and to the second flexible membrane at a second end of the spacer so as to separate the first flexible membrane from the second flexible membrane, the hollow spacer enabling the transmission of engine-generated sound pulses from the first membrane to the second membrane.

### CROSS-REFERENCE TO RELATED APPLICATIONS

This application claims priority to GB Patent Application Serial No. 2312768.1, filed on Aug. 21, 2023, the contents of which are hereby incorporated by reference.

### FIELD OF THE INVENTION

This invention relates to the transmission of engine-generated sound pulses into an auditory environment.

### BACKGROUND

High performance sports cars are known for their dynamic performance and aesthetic appeal. These cars are typically powered, at least in part, by an internal combustion engine (ICE). The ICE typically uses a liquid fuel such as petrol or diesel and ignites that fuel to generate rapidly expanding combustion gases which are used to generate kinetic energy. The combustion gases are then purged from the ICE via an exhaust system that connects an outlet of the ICE to the exterior of the car.

An important factor that a consumer may consider when looking to purchase a sports car is the quality of sound that is generated by the car, as this sound is seen to be indicative of the performance of its ICE. The quality of sound is assessed by the loudness of sound and the frequencies present in that sound. Sound quality is also an important factor in enabling a driver to assess the status of their car, and to determine whether there are any issues with its ICE.

The quality of sound that is naturally generated by an ICE has been impacted by modern emissions standards that limit the amount of exhaust gases that can be outputted by road vehicles. The standards require the insertion of gas treatment devices such as catalytic converters into the exhaust systems of vehicles. Such devices filter particulates out of the combustion gases that are purged from the ICE and affect the sound waves carried by those gases. The result of the presence of gas treatment devices in the exhaust system is that the quality of sound emitted from the car is reduced.

To circumvent the limitations introduced by modern emissions standards, sports cars may comprise one or more sound bypass device. A sound bypass device is a device that extracts sounds carried by exhaust gas before at least one gas treatment device in the exhaust system of the car and transmit those sounds to an environment where they can be experienced by an occupant or observer of the car. Advancements in sound bypass devices are currently being explored to optimise the quality of sound that they are able to emit.

### SUMMARY

According to a first aspect of the present invention there is provided a sound bypass device configured to transmit engine-generated sound pulses from an engine to an auditory environment whilst preventing the flow of gases to the auditory environment, the sound bypass device comprising: a chamber enclosing an internal volume between an inlet of the chamber and an outlet of the chamber, the inlet of the chamber being configured to receive gases exiting or entering the engine of the vehicle and the outlet of the chamber being configured to transmit sound pulses to the auditory environment; a first flexible membrane located within the chamber, the first flexible membrane being configured to transmit engine-generated sound pulses from the gases whilst preventing the movement of fluids from the inlet of the chamber to the outlet of the chamber; a second flexible membrane that is separated from the first flexible membrane within the chamber; and a hollow spacer coupled to the first flexible membrane at a first end of the spacer and to the second flexible membrane at a second end of the spacer to separate the first flexible membrane from the second flexible membrane, the hollow spacer enabling the transmission of sound pulses from the first membrane to the second membrane.

The hollow spacer may enclose a volume of fluid between the first membrane and the second membrane such that secondary sound pulses can pass from the first flexible membrane to the second flexible membrane via the fluid.

The internal volume of the chamber may comprise a length that extends between the inlet of the chamber and the outlet of the chamber and a cross-sectional area that is perpendicular to the length, wherein each of the first and second flexible membranes are located within the chamber such that they cover the cross-sectional area of the internal volume.

The hollow spacer may have a length that extends between the first flexible membrane and the second flexible membrane and a cross-sectional area that is perpendicular to that length, and wherein the cross-sectional area of the spacer is smaller than the areas of the first and second flexible membranes.

The enclosed volume of the hollow spacer may be cylindrical in shape.

The hollow spacer may comprise a first flange for coupling to the first flexible membrane and a second flange for coupling to the second membrane.

The hollow spacer may be coupled to the first and second flexible membranes by an adhesive substance.

The volume of fluid that is enclosed within the hollow spacer may be a volume of air.

Each of the first and second flexible membranes may comprise a planar member that is connected to the internal volume of the chamber by a suspension mechanism.

Each suspension mechanism may comprise a rim with an undulating surface that surrounds its respective planar member.

The undulating surface of the rim may follow the path of a sinusoidal wave.

The suspension mechanism may be constructed from a polymer material.

Each of the first and second flexible membranes may comprise an inner surface that couples to the hollow spacer and an outer surface located on an opposing side of the respective membrane to the inner surface.

Each of the first and second flexible membranes may comprise a planar component defining the inner surface of the membrane and being coupled to the hollow spacer; and a covering portion defining at least part of the outer surface of the membrane, the covering portion being coupled around the circumference of the planar component; wherein, for each of the first and second membranes, the planar ring and the covering portion are constructed from materials of different elasticity.

The covering portion of each of the first and second membranes may be located on the outer surface of its respective membrane.

The planar component of each of the first and second flexible membranes may be constructed from a sheet of metal.

The covering portion of each of the first and second flexible membranes may be constructed from a polyester film.

The internal volume of the chamber may have a first portion that is located between the inlet of the chamber and the first membrane and a second portion that is located between the second membrane and the outlet, wherein the cross-sectional area of the first portion of the internal volume increases as it extends between the inlet and the first membrane.

The rate of increase of cross-sectional area of the first portion of the internal volume may be constant as it extends between the inlet and the first membrane.

The cross-sectional area of second portion may be constant between the second membrane and the outlet.

The internal volume of the chamber may further comprise a third portion that extends between the first and second membranes.

The cross-sectional area of the third portion of the internal volume may be constant between the first flexible membrane and the second flexible membrane.

The first flexible membrane may be coupled to the chamber by a protrusion of the first flexible membrane that is located within a first cavity formed within the housing of the chamber.

The second flexible membrane may be coupled to the chamber by a protrusion of the second flexible membrane that is located within a second cavity formed within the housing of the chamber.

The auditory environment may be the cabin of the vehicle.

According to a second aspect of the present invention there is provided a vehicle comprising the sound bypass device described above.

### BRIEF DESCRIPTION OF THE DRAWINGS

The present invention will now be described by way of example with reference to the accompanying drawings. In the drawings:

FIG. 1 illustrates a schematic diagram of a vehicle comprising a sound bypass device;

FIG. 2 illustrates the arrangement of a sound bypass device for insertion into the vehicle of FIG. 1;

FIG. 3 illustrates a portion of the improved sound bypass device of FIG. 2 in further detail.

### DETAILED DESCRIPTION

The following description is presented to enable any person skilled in the art to make and use the invention and is provided in the context of a particular application. Various modifications to the disclosed embodiments will be readily apparent to those skilled in the art.

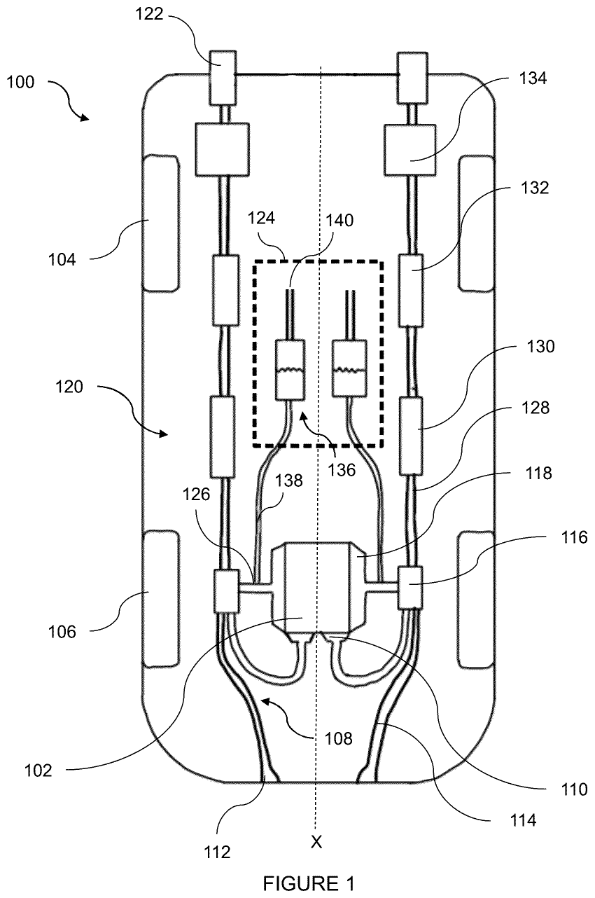

FIG. 1 illustrates an example of a vehicle 100. In this example, the vehicle comprises an arrangement of components that is symmetrical about a line X. The line X traverses the length of the vehicle 100 and bisects the width of the vehicle. Thus, the number and arrangement of components on a first side of this line X are the same as the number and arrangement of components on the second side of the line. Each type of component comprised within the vehicle 100 has only been labelled once in FIG. 1. It would be understood by the skilled person that, as the vehicle is symmetrical about the line X, a component labelled on a first side of the line X corresponds to the same component located on the second side of the line X. The vehicle arrangement illustrated in FIG. 1 is for exemplary purposes only and it would be understood that this is not limiting to the exact arrangement of components that may be comprised within a vehicle according to the present invention.

The vehicle 100 comprises an internal combustion engine (ICE) 102, which may be coupled to a drive system for the transference of an engine torque to other components of the vehicle. More specifically the torque generated by the combustion engine 102 may be transferred from the combustion engine 102 to moveable elements 104 of the vehicle 100. Alternatively, combustion engine 102 may be coupled to the drive system for the transference of an engine torque to one or more first electrical machines for the generation of drive power. The one or more first electrical machines may be coupled to one or more second electrical machines to receive the drive power and generate motor torques to moveable elements 104 of the vehicle 100. These electrical machines together with the combustion engine 102 may together form a powertrain of the vehicle 100.

The combustion engine 102 of vehicle 100 could be a straight, flat or V-engine having any number of cylinders. The combustion engine 102 may be part of a hybrid drive system for the vehicle. For example, the internal combustion engine may be part of a parallel hybrid drive system whereby one or more electrical machines and the internal combustion engine each generate torques that can be used separately and/or in combination to drive the vehicle. In an alternative example, the internal combustion engine may be part of a series hybrid drive system whereby the internal combustion engine is coupled to one or more first electrical machines which generate power from the engine torque generated by the internal combustion engine. The power generated by the one or more first electrical machines may be transferred to one or more second electrical machines to generate motor torques for driving the vehicle.

The vehicle 100 may comprise a plurality of movable elements 104, 106 for supporting the vehicle 100 on a surface. In the example illustrated in FIG. 1, the moveable elements are wheels. However, it would be appreciated that the moveable elements may be any alternative components that can support the vehicle on a surface and transferring engine torque into a driving force for the vehicle, such as tracks. The moveable elements will from this point forward be referred to as wheels. Some of those wheels may be drive wheels, such as wheels 104. Some wheels may be non-drive wheels, such as wheels 106. It will be appreciated that any configuration of drive 104 and non-drive 106 wheels may be used depending on the drive characteristics of the vehicle 100.

The vehicle 100 may comprise an air intake system 108 for providing a supply of air to the combustion engine 102. The air intake system 108 may comprise an intake manifold 110 that is fed an air mixture by at least one intake port. In the example shown in FIG. 1, the vehicle comprises two intake manifolds 110 that are fed an air mixture by air inlet pipes 114. Air flows into the intake system from one or more intake inlets 112 via the air inlet pipes 114. Generally, the intake inlets 112 are located on the exterior of the vehicle to permit air to flow into the inlets. The flow of air into the intake system may be assisted by one or more induction devices. The induction devices may be one or more turbochargers and/or superchargers. In the example shown in FIG. 1, a turbocharger 116 is provided for each intake manifold. Each turbocharger 116 is connected between the intake inlet 112 and its respective intake manifold 110.

The flow of air mixture, via the at least one intake inlet 112, into the intake manifold 110 may be regulated by at least one throttle. The intake manifold 110 permits the flow of the air mixture from the intake inlets 112 to the one or more cylinders of the combustion engine 102. The one or more cylinders each house a piston which is caused to move by the ignition of fuel present in the respective cylinder. The pistons are each coupled to a drive an axel of the combustion engine 102 to enable generation of the engine torque by means of the movement of the pistons. The entry and exit of gases into and out of the cylinders are regulated by a plurality of valves for each cylinder. The plurality of valves comprises intake and exhaust valves. Generally, the intake valves regulate the flow of combustion gases into a cylinder and the exhaust valves regulate the flow of exhaust gases out of a cylinder.

The combustion engine 102 may comprise one or more exhaust manifolds 118 which collect the exhaust gases expelled from the cylinders of the combustion engine 102. The exhaust gases are expelled from the cylinders via the plurality of exhaust valves. In the example shown in FIG. 1, the combustion engine 102 comprises two exhaust manifolds 118. Each exhaust manifold collects exhaust gases expelled from a separate set of cylinders of the combustion engine 102.

The vehicle 100 further comprises an exhaust system 120 which channels the exhaust gases from the exhaust manifold to at least one vehicle exhaust outlet 122. If there is only one exhaust manifold present in the vehicle, then the exhaust system 120 may channel the exhaust gases from that exhaust manifold to at least one vehicle exhaust outlet 122. In some vehicles there may be more than one vehicle exhaust outlet 122 to which the exhaust gases are channels from the one exhaust manifold. In the example shown in FIG. 1, the combustion engine 102 comprises two exhaust manifolds and the exhaust system 120 channels exhaust gases from a first exhaust manifold to at least one first exhaust outlets and from a second exhaust manifold to at least one second exhaust outlets. The exhaust system may combine the flows of exhaust gases from multiple exhaust manifolds along the path from the exhaust manifolds to at least one vehicle exhaust outlet 122.

The exhaust system 120 may comprise one or more exhaust components 116, 130, 132, 134 that acts on the exhaust gases being channelled through the exhaust system. The one or more exhaust components may comprise a turbocharger 116. An exhaust inlet of the turbocharger 116 may be connected to the exhaust manifold 118 by a primary exhaust pipe 126. The exhaust inlet permits exhaust gases to flow into the turbocharger 116. An exhaust outlet of the turbocharger 116 may permit exhaust gases to flow out of the turbocharger 116. The exhaust outlet may be connected to a secondary exhaust pipe 128 to channel the exhaust gases towards the one or more exhaust outlets. The turbocharger assists the flow of air into the intake manifold by obtaining power from the flow of the exhaust gases through the turbocharger. The turbocharger may comprise a first impeller which assists the flow of air into the intake manifold. This first impeller can be powered by the flow of exhaust gases flowing over a second impeller connected to the first impeller. The turbocharger comprises the second impeller. The presence of the turbocharger in the flow path of the exhaust gases from the exhaust manifold to the one or more exhaust outlets alters the engine sounds that are transmitted along the exhaust system to the one or more vehicle exhaust outlets 122. This may mean that the engine sounds from the engine are muffled or otherwise changed. For instance, a turbocharger can add a whining sound to the engine sound being transmitted along the exhaust system.

The one or more exhaust components may alternatively or additionally comprise an exhaust gas treatment device 130, 132, 134. The exhaust system may comprise more than one exhaust gas treatment device for each channel of exhaust gases from the exhaust manifold to exhaust outlet(s). Examples of exhaust gas treatment devices are catalytic convertors, and gasoline particulate filters otherwise known as anti-particulate filters. Each of these devices acts on the exhaust gases in some way to change the constituents of the exhaust gases. The exhaust system may comprise a catalyst followed by an anti-particulate filter in series connected by secondary exhaust pipes 128. The exhaust system may comprise a catalyst followed by an anti-particulate filter in series connected by secondary exhaust pipes 128 for each channel between an exhaust manifold 118 and the vehicle exhaust outlet 122.

The vehicle illustrated in FIG. 1 comprises a turbocharger 116, a catalytic convertor 132 and an anti-particulate filter 134 along a first set of secondary exhaust pipes 128 that channel exhaust gases from a first exhaust manifold to at least one exhaust outlet. These exhaust components also act on the exhaust gases produced by the combustion engine 102 to alter the sound of the engine that is transmitted along the exhaust system to the one or more vehicle exhaust outlets 122. The changes to the engine sounds that are produced by the exhaust components and transmitted along the exhaust system can be detrimental to the perception of the vehicle in certain circumstances. For instance, if the vehicle is a high-performance sports car, then the exhaust components may serve to alter the sounds emanating from the exhaust outlets such that there is a reduction in the perception that the vehicle is high-performance.

To address this issue, the vehicle is provided with at least one sound bypass device 136. The sound bypass device 136 is configured to transmit the engine generated sounds from the engine of the vehicle to an auditory environment. The sound bypass device 136 comprises a sound input that is fed by a tube 138 that bypasses the exhaust system of the vehicle. The sound bypass device further comprises a sound output 140 located at the auditory environment. The auditory environment may be any environment to which engine sounds may be transmitted. In an example, the auditory environment may be internal to (i.e., inside) the vehicle. In another example, the auditory environment may be external to (i.e., outside) the vehicle. In the example illustrated in FIG. 1, the auditory environment may be the cabin 124 of the vehicle. The cabin of the vehicle is a compartment of the vehicle within which a user, or driver, of the vehicle can be located. The sound bypass device 136 is configured to transmit engine-generated sounds but not to permit the flow of exhaust gases. In other words, the sound bypass device 136 is configured to prevent the flow of exhaust gases through the sound bypass device 136.

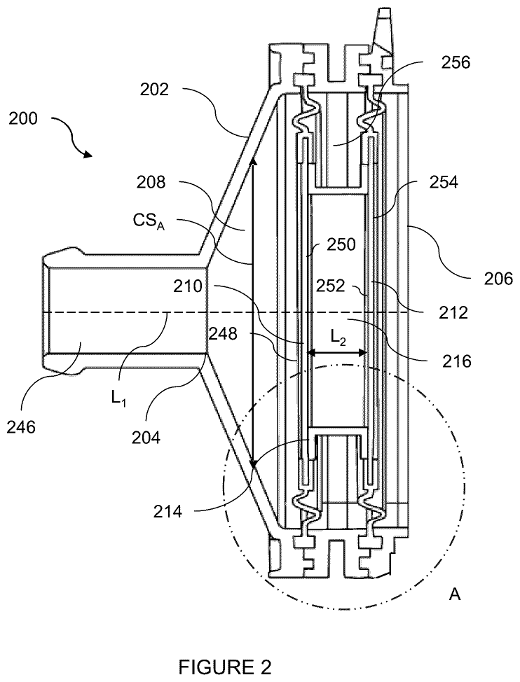

The configuration of a sound bypass device 200 to be inserted into the vehicle of FIG. 1 is illustrated in FIG. 2. The sound bypass device 200 may, for example, correspond to or replace the device 136 in FIG. 1.

The sound bypass device 200 is configured to transmit engine-generated sound pulses from an engine to an auditory environment whilst preventing flow of exhaust gases to the auditory environment. That is, the sound bypass device 200 is configured to transfer noise from the engine of a vehicle, and to provide that noise to an auditory environment. The auditory environment may be any environment external to the sound bypass device that is able to receive sound pulses. The auditory environment may be either external or internal to the vehicle. The sound bypass device 200 may be described as acoustically permeable, as sound pulses can be transmitted through the device. At the same time, the sound bypass device 200 is configured to prevent the flow of gases from the engine of the vehicle to the auditory environment. That is, the sound bypass device 200 prohibits exhaust gases from the engine from passing to the auditory environment. The sound bypass device 200 may be described as pneumatically impermeable. Thus, the sound bypass device 200 is configured to transfer high quality engine noise to the auditory environment whilst protecting the auditory environment, and any persons in that environment, from the exhaust gases transmitting that noise.

The sound bypass device comprises a chamber 202. The chamber comprises an inlet 204 and an outlet 206. The inlet 204 to the chamber is configured to receive gases exiting or entering the engine of the vehicle. Gases exiting the vehicle are those that are provided to the sound bypass device from a location on the exhaust system of the vehicle. Gases entering the engine of the vehicle are those that are provided to the sound bypass device from a location on the air intake system of the vehicle. The sound inlet 204 may comprise an orifice, or opening, through which exhaust gases can flow into the device. The inlet 204 may be connected to a first location on the exhaust system of the vehicle. The inlet 204 may be supplied with exhaust gases by a further vehicle component, such as a pipe or tube 246. That is, the inlet 204 may be connected to a pipe or tube 246 from which exhaust gases (and corresponding sound pulses) are provided to the inlet 204. The pipe or tube 246 may correspond to tube 138 of FIG. 1. The inlet 204 may be cylindrical in shape. The inlet 204 may itself be a protrusion that extends from a further portion of the chamber 202. In a specific example, the inlet 204 may itself be defined as a pipe. The inlet 204 may define a first end of the sound transmission device.

The inlet 204 may be configured to connect to any suitable component of the vehicle so that engine-generated sound pulses can be transferred from the engine to the bypass device. The inlet 204 may be connected to a first location on the exhaust system before one of the exhaust components along the flow path of the exhaust gases. That is, the inlet 204 is located closer to the exhaust manifold along the flow of the exhaust gases within the exhaust system than that exhaust component. The inlet 204 may be connected to the exhaust system before all the exhaust components. That is, the inlet 204 may be connected to the exhaust system between the exhaust manifold and the first exhaust component along the exhaust system in the direction of flow of the exhaust gases. As described in more detail below, the first exhaust component may be a catalytic converter of the vehicle. The inlet 204 may alternatively be connected to a location on the air intake for the combustion engine of the vehicle. More specifically, the inlet 204 may be connected to the high-pressure plenum and/or ducts that are located on the air intake before the combustion engine.

The outlet 206 of the chamber is configured to transmit sound pulses to the auditory environment. The outlet 206 may define a second end of the sound transmission device. The outlet 206 may comprise an orifice or opening. The outlet 206 may be covered by at least one sheet of material. The sound outlet 206 will be discussed in further detail below.

The chamber 202 extends between its inlet 204 and its outlet 206 and encloses an internal volume 208 between the inlet and the outlet. Thus, the inlet 204 is located at a first end of the chamber and the outlet 206 is located at a second end of the chamber. The chamber 202 is therefore defined by the inlet 204 and the outlet 206. The chamber 202 is enclosed between the inlet 204 and the outlet 206. More specifically, the chamber 202 encloses an internal volume 208 between the inlet 204 and the outlet 206. The chamber 202 is bounded by walls that seal the internal volume 208 of the chamber 202. The walls of the chamber 202 may be rigid. That is, the walls of the chamber 202 may be resistant to bending. Thus, the chamber 202 may have structural rigidity that is able to withstand the temperatures and pressures of exhaust gases. The walls of the chamber 202 may alternatively be flexible (or moveable). The walls of the chamber 202 may otherwise be referred to as the housing of the chamber. Gases received by the inlet 204 are sealed, or confined, within the chamber 202. The internal volume 208 of the chamber may have a length L₁ that extends between the inlet 204 of the chamber and the outlet 206 of the chamber. The internal volume 208 of the chamber may further comprise a cross-sectional area CSA that is perpendicular to the length of the chamber 202. The cross-sectional area of the chamber may be constant along the length of the chamber 202. In an alternative example, the cross-sectional area may vary along the length of the chamber 202.

The sound bypass device comprises a first membrane 210 located within the chamber 202. The first membrane 210 is configured to transmit engine-generated sound pulses from gases received from the inlet 204 whilst preventing the movement of fluids through the sound bypass device. That is, the first membrane 210 is configured to conduct engine noise through the sound bypass device. The first membrane 210 is therefore permeable to noise (or acoustically permeable). Also, fluids are not able to pass through the first membrane 210 to the sound outlet 206. The first membrane 210 is therefore impermeable to gases (or pneumatically impermeable). The first membrane 210 is also impermeable to liquids. The first membrane 210 may separate, or divide, the chamber 210. The first membrane 210 may be located in the chamber such that it covers the cross-sectional area of the internal volume 208. Specifically, the first membrane 210 may cover the cross-sectional area of the internal volume 208 at the position along the length of the chamber at which it is located. The ability of the first membrane 210 to cover the cross-sectional area means that the first membrane 210 acts to seal the chamber to prevent fluids from passing through the membrane. The first membrane 210 may comprise a first surface 248 that faces the inlet 204 of the chamber. The first surface 248 may be referred to as an outer surface, for reasons that are described in further detail below. The first membrane 210 is configured to transmit engine-generated sound pulses by deflecting in response to pressure generated by those pulses. That is, the first membrane 210 may deflect in response to pressure variations in the gas from the inlet 204 that impacts its first surface. The first membrane 210 may comprise a second surface 250. As the membrane deflects in response to pressure variations, it can pass those variations onto fluids located on its second surface 250. The second surface 250 of the membrane may be referred to as an inner surface, for reasons that are described in further detail below. In this way, the engine-generated sound pulses can be passed from the first side to the second side of the first membrane. As it is configured to deflect in response to sound pulses, the first membrane 210 may be referred to as a “flexible membrane”.

The sound bypass device further comprises a second membrane 212 that is also located within the chamber. The second membrane 212 is configured to transmit engine-generated sound pulses from gases received from first membrane 210. The second membrane 212 is therefore permeable to noise (or acoustically permeable). The second membrane 212 may prevent the movement of gases through the sound bypass device. That is, the second membrane 212 may be impermeable to gases (or pneumatically impermeable). The second membrane 212 may alternatively be semi, or fully, impermeable to gases. The second membrane 212 may separate, or divide, the chamber 202. The second membrane 212 may be located in the chamber such that it covers the cross-sectional area of the internal volume 208. Specifically, the second membrane 212 may cover the cross-sectional area of the internal volume 208 at the position along the length of the chamber at which it is located. The ability of the second membrane 212 to cover the cross-sectional area means that the second membrane 212 acts to seal the chamber to prevent gases from passing through the membrane. The second membrane 212 may comprise a first surface 252 that faces the first membrane 210. The first surface 252 of the second membrane 212 may be referred to as the inner surface of the second membrane. The second membrane 212 is separated from the first membrane 210 within the chamber. That is, there is a non-zero distance between the first membrane and the second membrane within the chamber. The non-zero distance extends in a direction that passes from the inlet 204 to the outlet 206 of the chamber. The non-zero distance means that the second membrane 212 does not at any point touch the first membrane 210.

As with the first membrane, the second membrane 212 may deflect in response to pressure variations in fluids passing between the second surface of the first membrane 210 and the first surface of the second membrane 212. The second membrane 212 may comprise a second surface 254. As the second membrane 212 deflects in response to pressure variations, it can pass the variations onto fluids located on its second surface 254. The second surface 254 of the second membrane 212 faces the outlet 206 of the chamber. The second surface 254 of the second membrane 212 may be referred to as the outer surface of the second membrane. Thus, engine-generated sound pulses can be passed from the first side to the second side of the second membrane 212. As with the first membrane, the second membrane 212 may be referred to as a “flexible membrane”.

The sound bypass device further comprises a hollow spacer 214 located within the chamber. The hollow spacer 214 is a mechanical device that comprises at least one structural wall that is used to provide separation. The hollow spacer is configured to provide the separation between the first membrane 210 and the second membrane 212. The hollow spacer 214 is coupled to the first membrane 210 at a first end of the spacer. That is, the hollow spacer 214 is attached to the first membrane 210 at its first end. The hollow spacer is coupled to the second membrane 212 at a second end of the spacer. That is, the hollow spacer 214 is attached to the second membrane 212 at its second end. Thus, the hollow spacer acts to separate the first membrane 210 from the second membrane 212.

The hollow spacer 214 may act as a connecting means between the first membrane 210 and the second membrane 212. That is, the hollow spacer may pneumatically connect the first membrane 210 to the second membrane 212. The purpose of the hollow spacer is to transfer sound pulses from the first membrane 210 to the second membrane 212. By connecting the first membrane 210 to the second membrane 212, the hollow spacer may allow the second membrane 212 to move in accordance with the first membrane 210. In other words, the hollow spacer 214 enables the transmission of engine-generated sound pulses from the first membrane 210 to the second membrane 212. These sound pulses are transmitted via the mechanical connection of the first and second membranes to the spacer 214. The engine-generated sound pulses that are transferred from the first membrane 210 to the second membrane 212 due to the mechanical coupling of the membranes to the hollow spacer may be referred to as primary sound pulses.

It is mentioned above that each of the first and second membranes 210, 212 comprises a first and second surface. The first surface 248 of the first membrane 210 and the second surface 254 of the second membrane 212 may be referred to as outer surfaces. These surfaces are labelled as such because they face away from the hollow spacer 214 that connects the first and second membranes 210,212, and towards a respective end of the chamber 202. Similarly, the second surface 250 of the first membrane 210 and the first surface 252 of the second membrane 212 may be referred to as inner surfaces. These surfaces are labelled as such because they face towards the hollow spacer 214.

The hollow spacer 214 is, by its nature, hollow. This means that the spacer has an empty space, or cavity, 216 located within its at least one structural wall. The cavity 216 in the spacer may be located between the first membrane 210 and the second membrane 214. The hollow spacer may have a length L₂ that extends between first membrane 210 and the second membrane 212. The cavity 216 of the spacer may be bounded by the first membrane 210 at its first end, by the second membrane 212 at its second end and by the walls of the spacer along its length L₂. The length L₂ of the hollow spacer may extend in a direction that is parallel to the length L₁ of the chamber 202. The hollow spacer 214 may have a cross-sectional area that is perpendicular to its length. The cross-sectional area of the hollow spacer may be constant along the length of the spacer. The cross-sectional area of the spacer may alternatively vary along the length of the spacer. The hollow spacer 214 may enclose a volume of fluid between the first membrane 210 and the second membrane 212. The fluid enclosed within the hollow spacer 210 may be excited by deflection of the second surface 248 of the first membrane 210. This may cause pressure variations in the fluid that can be passed through the cavity 216 of the spacer to the first surface of the second membrane 212. Thus, in addition to the sound pulses carried by the mechanical coupling of the membranes to the hollow spacer 214, further sound pulses may pass from the first membrane 210 to the second membrane 212 via the volume of fluid enclosed within the spacer. The sound pulses that pass from the first 210 membrane to the second membrane 212 via the fluid may be referred to as secondary sound pulses.

The fluid enclosed within the hollow spacer 214 may be any liquid or gas that is suitable for transferring sound pulses, or pressure variations, between the first membrane 210 and the second membrane 212. In an example, the volume of fluid that is enclosed within the hollow spacer 214 is a volume of air. In other words, the fluid that is enclosed within the hollow spacer 214 may be air. The presence of air in the enclosed volume of the hollow spacer 214 is advantageous as air is known to have good acoustic transmission properties. The term “air” is used to describe a gaseous mixture comprising at least nitrogen and oxygen that may reasonably found in an environment external to the vehicle. Any other suitable gas, other than air, may alternatively be used in the volume within the hollow spacer 214. Alternatively a liquid, such as water, may be used within the hollow spacer 214. The fluid within the hollow spacer may be selected in dependence on the sound frequencies that are desired to be emitted by the sound bypass device.

The cross-sectional area of the hollow spacer 214 may be smaller than the cross-sectional areas of the first and second membranes 210, 212. That is, the hollow spacer 214 may have a smaller width that those of the first and second membranes 210, 212. This means that the cross-sectional area of the internal volume, or cavity, 216 of the hollow spacer 214 is smaller than the internal volume 208 of the chamber 202. Thus, the chamber 202 comprises a volume that is located between the first and second membranes and is external to the hollow spacer 214. In other words, the separation of the first and second membranes may define two volumes: a first volume 216 that is enclosed by the hollow spacer 214 and a second volume 256 that is external to the hollow spacer.

The second volume 256 may, as with the first volume 216, comprise a fluid. The amount of fluid enclosed within the second volume 256 may be different to the volume of fluid within the first volume 216. The difference between the size of the first volume 216 and that of the second volume 256 affects the relative sound transmission properties of the volumes. In one example, if the second volume 256 is greater in size than the first volume 216. In this example, there is a greater quantity of fluid in the second volume 256 than in the first volume 216. The greater quantity of fluid requires more energy to be moved, and so sound waves will travel more slowly through the second volume 256 than in the first volume 216. This means that the sound transmitted through the second volume 256 will have a lower frequency than the sound transmitted through the first volume 216. In alternative examples the first volume 216 may be greater than the second volume 256, or the first and second volumes may be equal in size. The type of fluid in the first volume 216 may be different from the type of fluid in the second volume 256. Thus, the fluid in the first volume 216 may have a different density to the fluid in the first volume 216. This further affects the variation in sound transmitted through the first volume 216 and sound transmitted through the second volume 256.

The enclosed volume 216 of the hollow spacer 214 is a three-dimensional volume that holds a quantity of fluid. The enclosed volume 216 may be of any suitable shape. The enclosed volume may be prismatic. That is, the enclosed volume 216 may have two ends of identical surface area and a length L₂ that extends between those two ends. The enclosed volume may, in a specific example, be cylindrical in shape. That is, the two ends of the enclosed volume 216 may have a circular cross-sectional area. The use of a cylindrical spacer is advantageous as cylindrical shapes are easier to manufacture, using a reduced number of welding joints to prismatic structures of other shapes. Furthermore, stress concentrations in the fluid enclosed within the volume are reduced by the absence of corners.

As mentioned above, the chamber 202 may have either a constant or a variable cross-sectional area along its length. The shape of the cross-sectional area of the chamber 202 may be of any suitable shape. In one example, the cross-sectional area of the chamber may be circular. The chamber 202 may have an internal volume 208 that is defined by a circular cross-sectional area. The internal volume 208 of the chamber may have a conical shape. The chamber may more specifically be shaped, at least partially, as a frustrum. The shaping of the chamber in this way enables the chamber 202 to act as a loudspeaker cone. The cross-sectional area of the chamber 202 may increase between the inlet 204 and the outlet 206. A conical shape of the chamber 202 may be beneficial as it allows for the expansion of gases as they pass from the inlet 204 to the outlet 206 of the chamber 202.

The hollow spacer 214 may further comprise flanges for coupling to each of the first and second membranes. More specifically, the hollow spacer 214 may comprise a first flange 218 for coupling to the first membrane 210, and a second flange 220 for coupling to the second membrane 212. A flange is a projecting rim, or collar, that is added to a structural component to strengthen that component. The first and second flanges 218, 220 of the hollow spacer may be planar. That is, the first and second flanges 218, 220 may have a negligible depth when compared to their width. The first and second flanges 218, 220, by their definition, have outer dimensions that are larger in at least their width than the corresponding internal volume 216 of the hollow spacer. The first and second flanges 218, 220 may assist with the attachment of the hollow spacer 214 to the first and second membranes 210, 212. A further advantage of the first and second flanges 218, 220 is that they are leak proof, securing the enclosed volume 216 of the hollow spacer 214 when it is attached to the first and second membranes 210, 212 to prevent the escape of fluids.

The hollow spacer 214 may be coupled to the first and second membranes 210, 212 by any suitable means. In one example, the hollow spacer 214 may be coupled to each membrane 210, 212 by a welded joint. In a further example, the hollow spacer 214 may be coupled to each membrane 210, 212 by mechanical fasteners such as rivets or bolts. Alternatively, the hollow spacer 214 may be coupled to the first and second membranes 210, 212 by an adhesive substance. An adhesive substance is one that is used to stick two materials together. The adhesive substance may comprise a solvent such as acetone, methyl acetate or ethyl acetate. An advantage to the use of an adhesive substance to couple the hollow spacer 214 to the first and second membranes 210, 212 is that such substances provide a lightweight means of securing components together. Additionally, the absence of mechanical fasteners to couple the components together maintains the acoustic transmissibility of the membranes 210, 212 and spacer 214.

Each of the first and second membranes 210, 212 may further comprise a planar member that is connected to the internal volume 208 of the chamber by a suspension mechanism 258, 260. The planar member of each membrane may be a flat sheet of material. A planar member is a member that has a negligible depth when compared to its length and width. In one example, the first membrane 210 may be comprised of a single sheet of material. That is, the first membrane 210 may be comprised of a single, or only one, component. In another example, the first membrane 210 may be comprised of more than one sheet of material. The planar member of the first membrane 210 may have a cross-sectional area of any suitable shape. In one example, the planar member may have a circular cross-sectional area. A circular cross-sectional area for the planar member may complement the circular cross-sectional area of the chamber 202. Similarly to the first membrane 210, the second membrane 212 may be comprised of a single sheet of material. That is, the second membrane 212 may be comprised of a single, or only one, component. In another example, the second membrane 212 may be comprised of more than one sheet of material. The planar member of the second membrane 212 may have a cross-sectional area of any suitable shape, such as circular.

The suspension mechanism 258, 260 of the first and second membranes 210, 212 is a component that is configured to couple the planar member of the membranes to the housing of the chamber 202. The suspension mechanism may be referred to as such because it may comprise an elastic or spring-like portion that absorbs vibrations of its respective membrane. The suspension mechanism 258, 260 may surround the outer perimeter of the planar member of each of the first and second membranes. In this way, the planar member may act as a seal that prevents gas or other fluids from escaping around the periphery of the planar member of each membrane.

Each suspension mechanism 258, 260 of the first and second membrane 210, 212 comprises a gripping portion 226, 230 and a rim 222, 224 that surrounds its respective planar member. The rim 222, 224 may extend around the perimeter of its respective planar member. The rim 222, 224 may attach at a first end to an internal wall of the chamber and at a second end to the gripping portion 226, 230 of the suspension mechanism. The gripping portion 226, 230 of the suspension mechanism may attach to the planar member. The rim 222, 224 may thereby cover the cross-sectional area of the chamber between the housing of the chamber and the planar member. By covering the cross-sectional area of the chamber, the rim may thereby seal the chamber to prevent fluids from passing through the membranes. The gripping portion 226, 230 of the suspension mechanism may be referred to as such because it may grip its respective planar member to secure the planar member in place within the chamber 202. The gripping portion 226, 230 of the suspension mechanism may comprise two parallel tines extending distally of the housing of the chamber. The planar member may be secured between the two parallel tines. The planar member may be secured by any suitable means. In one example, the planar member may be secured to the gripping portion by way of a compression fit. In another example, the planar member may be secured to the gripping portion 226, 230 through use to the adhesive.

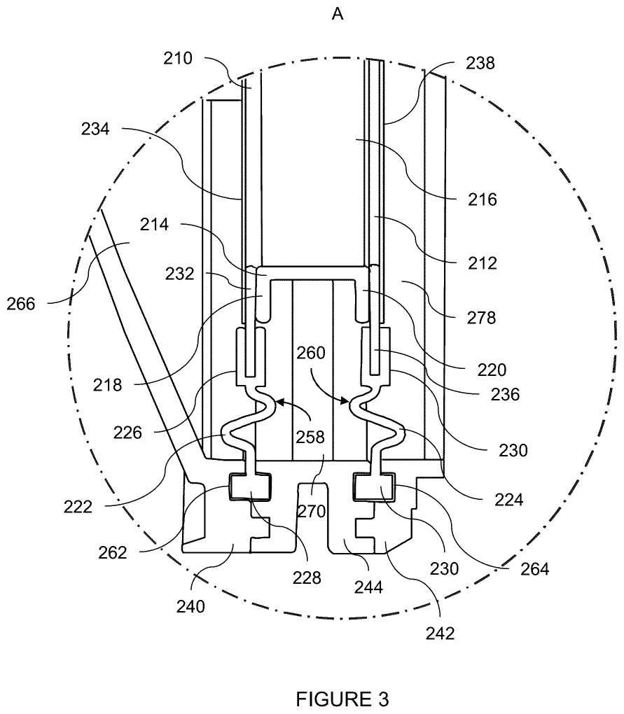

The rim 222, 224 of the suspension mechanism 258, 260 may comprise an undulating, or oscillating, surface. That is, the rim 222, 224 may have a wave-like shape. The undulating, or wave-like shape, may be observed in cross-section as exemplified in FIGS. 2 and 3. In one example, the undulating surface of the rim 222, 224 may follow the path of a sinusoidal wave. The sinusoidal shape of the undulating surface may be one wavelength in length. The undulating surface of the rim 222, 224 may otherwise be described as corrugated. A corrugated sheet of material is one that is shaped into a series of parallel ridges and grooves. The corrugated configuration of the support structure is advantageous as it provides added rigidity, or strength, to the membrane.

The suspension mechanism 258, 260 may be constructed from a polymer material. In a more specific example, the suspension mechanism 258, 260 may be constructed of rubber. The construction of the suspension mechanism 258, 260 from a material such as rubber is advantageous as such materials are known for their abrasion resistance, tensile strength, and tear strength. Thus, the use of a polymer for the suspension mechanism 258, 260, and specifically of a rubber polymer, allows flexibility of the first and second membranes 210, 212 whilst ensuring that the membranes do not rupture. The use of such materials therefore presents safety advantages.

The planar member of each of the first and second membranes 210, 212 may comprise a planar component 232, 236. In one example, the planar component 232, 236 may be a planar disk. That is, the planar component 232, 236 may comprise a flat, thin, circular layer of material. The planar component 232, 236 may have a hole in it its middle. The hole may be circular. Thus, the planar component 232, 236 may have the shape of a toroid. The planar component 232, 236 may have any alternative two-dimensional shape. The planar component 232, 236 may define the inner surface of each of the first and second membranes 210, 212. That is, the planar component 232, 236 of each membrane may face towards the hollow spacer 214. The planar component 232, 236 may be being coupled to the hollow spacer 214. Each planar member may further comprise a covering portion 234, 238. The covering portion 234, 238 may also have a thin, flat, circular shape. The covering portion 234, 238 may have the shape of a complete circle. The covering portion 234, 238 may have any alternative two-dimensional shape. The planar component 232, 236 and the covering portion 234, 238, for each of the first and second membranes, may be configured so that the covering portion is secured to the planar component but also so that the support structure protrudes outwardly from the covering portion around the perimeter of the covering portion. The covering portion 234, 238 may define the outer surface of each of the first and second membranes. That is, the covering portion 234, 238 may face towards the inlet or outlet of the chamber, respectively. The covering portion 234, 238 may act to cover a hole in the middle of the planar component.

The planar component 232, 236 and the covering portion 234, 238 may be constructed from different materials. More specifically, the planar component 232, 236 may be constructed from a material that has a different level of elasticity from the covering portion 234, 238. The planar component 232, 236 may have a lower level of elasticity that the covering portion 234, 238. The lower relative level of elasticity of the planar component 232, 236 supports the primary function of the planar component, which is to support the covering portion 234, 238. The higher relative level of elasticity of the covering portion 234, 238 supports the primary purpose of the covering portion 234, 238, which is to deflect in response to pressure variations to pass acoustic vibrations from a first side to a second side of each of the first and second membranes 210, 212.

The planar component 232, 236 of each of the first and second membranes 210, 212 may be constructed from any suitable material. In a specific example, the planar component 232, 236 may be constructed from a metallic material. More specifically, the planar component 232, 236 may be constructed from a sheet of metal. For example, the planar component 232, 236 may be constructed from a sheet of aluminium. Metals such as aluminium are known for their structural rigidity. Thus, constructing the planar components from this type of material assists the planar components 232, 236 in performing their structure of providing support for the first and second membranes 210, 212.

As mentioned above, the material from which the covering portion 234, 238 of each of the first and second membranes 210, 212 is constructed may be more flexible than the material from which the planar component 232, 236 is constructed. In other words, the covering portion 234, 238 may have a greater level of elasticity than the planar component. Whilst the function of the planar component 232, 236 is to provide support, the function of the covering portion 234, 238 is to vibrate in response to pressure fluctuations to transmit engine generated sound pulses from the inlet of the sound bypass device to the acoustic environment. In an example, the covering portion 234, 238 may be constructed from a polyester film. In a specific example, the covering portion 234, 238 may be constructed from mylar. Mylar, along with other similar polyester materials, is known for its heat-resistant properties and high tensile strength. Thus, constructing the covering portion 234, 238 from this sort of material allows it to vibrate in response to sound vibrations whilst also insulating the outlet 206 of the chamber from the heat and pollution of the exhaust gases received by the inlet 204.

The internal volume 208 of the chamber may be separated into a first portion 266 and a second portion 268. The first portion 266 of the internal volume 208 may be located between the inlet 204 of the chamber and the first membrane 210. That is, the first portion 266 of the internal volume 208 may extend between the inlet 204 and the first membrane 210 along the length L₁ of the chamber. The second portion 268 of the internal volume 208 of the chamber may be located between the second membrane 212 and the outlet 206 of the chamber. That is, the second portion 268 may extend between the second membrane 212 and the outlet 206 along the length L₁ of the chamber. The first portion 266 of the internal volume 208 may be defined by a first housing portion 240. That is, the housing of the chamber may comprise a first portion 240 that defines the first internal volume 266. The second portion 268 of the internal volume 208 may be defined by a second housing portion 242. That is, the housing of the chamber may comprise a second portion 242 that defines the second internal volume 268. The first and second housing portions 240, 242 may be physically separate components. The first and second housing portions 240, 242 may be connected together to form the chamber 202.

As described above, the chamber 202 may have an internal volume 208 that is defined by a circular cross-sectional area. In an example, the chamber 202 may be shaped at least partially like a frustrum. In a more specific example, the first portion 266 of the internal volume of the chamber 202 may be shaped like a frustrum. That is, the cross-sectional area of the first portion of the internal volume may increase as it extends between the inlet 204 and the first membrane. This means that the cross-sectional area of the chamber at the inlet 204 is smaller than the cross-sectional area of the chamber at the first membrane 210. A frustrum is a three-dimensional shape with a circular cross-sectional area. In alternative examples, the first portion 266 of the internal volume 208 may have a cross-sectional area of an alternative shape.

The rate of increase of the cross-sectional area of the first portion 266 of the internal volume 208 may be constant along the length of the first portion 266. That is, as the first portion 266 extends between the inlet 204 and the first membrane 210, its cross-sectional area may increase. The first portion 266 may taper from its second end, at which the first membrane 210 is located, to its first end at the inlet 204. The configuration of the chamber 202 so that the first portion 266 of its internal volume 208 is shaped in this way may improve the acoustic performance of the sound bypass device 200. This is because the conical configuration of the first portion 266 minimises sound loss as gases expand whilst they pass through the chamber, thereby improving the quality of sound vibrations that are provided to the first membrane 210. Furthermore, the conical configuration of the first volume 266 allows for the frequency of sound vibrations to be tuned as they pass through the first volume 266. The cross-sectional area of the second portion 268 of the internal volume 208 may be constant between the second membrane and the outlet of the chamber. That is, the cross-sectional area of the second portion 268 of the internal volume 208 may be the same at all points along the length of the chamber 202.

The internal volume 208 of the chamber may further comprise a third portion 270. The third portion 270 of the internal volume 208 may extend between the first and second membranes. That is, the third portion 270 of the internal volume 208 may extend between the first membrane 210 and the second membrane 212 along the length L₁ of the chamber. The third portion of the internal volume may therefore have substantially the same length as the hollow chamber 214. The third portion 270 of the internal volume 208 may be defined by a third housing portion 244. That is, the housing of the chamber may comprise, in addition to the first portion and the second portion 240, 242, a third housing portion 244 that defines the third portion of the internal volume. The third housing portion 244 may be a physically separate component from the first and second housing portions 240, 242. The third housing portion 244 may connect to the first housing portion 240 at a first end and the second housing portion 242 at a second end to form the chamber 202. The cross-sectional area of the third portion 270 of the internal volume 208 may be constant between the first membrane 210 and the second membrane 212. That is, the cross-sectional area of the third portion 270 may be the same at all points along the length of the chamber. The cross-sectional area of the third portion 270 may be the same as the cross-sectional area of the second portion 268. The constant cross-sectional areas of the second and/or third portions of the chamber 268, 270 is advantageous in attaching the sound bypass device to a panel or other vehicle component so that its outlet is proximal to an auditory environment.

The first membrane 210 may further comprise a first protrusion 228. The first protrusion 228 may extend distally from the support structure 258 of the first membrane 210. The first protrusion 228 may extend around the perimeter of the first membrane 210. The first protrusion 228 may be configured to couple the first membrane 210 to the chamber 202. More specifically, the first protrusion 228 may be coupled to the housing of at least one portion of the chamber 202. The first protrusion 228 may be housed within the at least one portion of the chamber 202. The first protrusion 228 may be located within a first cavity 262 formed within the housing of the chamber 202. The location of the first protrusion 228 within a cavity 262 of the chamber provides a secure point of attachment between the first membrane 210 and the housing of the chamber. The first cavity 262 of the chamber may be formed from a first recess in the first housing portion 240 and a second recess in the third housing portion 242. The formation of the first cavity 262 in this way eases in the assembly of the first membrane 210 within the sound bypass device 200.

Similarly to the first membrane 210, the second membrane 212 may further comprise a second protrusion 230. The second protrusion 230 may extend distally from the support structure 260 of the second membrane 212. The second protrusion 230 may extend around the perimeter of the second membrane 212. The second protrusion 230 may be configured to couple the second membrane 212 to the chamber 202. More specifically, the second protrusion 230 may be coupled to the housing of at least one portion of the chamber 202. The second protrusion 230 may be housed within the at least one portion of the chamber 202. The protrusion 230 may be located within a second cavity 264 formed within the housing of the chamber 202. The location of the second protrusion 230 within a cavity 264 of the chamber provides a secure point of attachment between the membrane and the housing of the chamber. The second cavity 264 of the chamber may be formed from a first recess in the second housing portion 242 and a second recess in the third housing portion 244. The formation of the second cavity 264 in this way eases in the assembly of the second membrane 212 within the sound bypass device 200.

As has been mentioned above, the auditory environment into which sound pulses are emitted from the outlet 206 of the chamber 202 may be any environment to which engine sounds may be transmitted. In one example, the auditory environment may be external to the vehicle. That is, the sound bypass device may be located at an external surface of the vehicle. More specifically, the outlet 206 of the chamber may be located at an external surface of the vehicle. This allows the sound bypass device to transmit sound pulses directly outside of the vehicle. The outlet 206 of the chamber may be located on an external panel of the body of the vehicle. The external panel may be located at any suitable location on the exterior of the vehicle, such as the door, roof, or rear end of the vehicle. The outlet 206 of the chamber may also be located on the exhaust tailpipe of the vehicle. In an alternative example, the auditory environment may be internal to the vehicle. In a more specific example, the auditory environment may be the cabin of the vehicle. As mentioned above, the cabin of the vehicle is a compartment of the vehicle within which a user, or driver, of the vehicle can be located. An advantage of the auditory environment being the cabin of the vehicle is that the sound pulses emitted from the sound bypass device may be provided directly to the user of a vehicle. The sound pulses may therefore be able to provide feedback as to the acoustic performance of the vehicle. This is a particularly advantageous feature of vehicles such as sports cars, in which the all-around performance of a vehicle is of great importance to its user. The acoustic feedback may be pleasing to the user. The acoustic feedback may also, in some examples, be used to indicate a problem with the vehicle to the user.

The apparatus described herein provides an effective means for amplifying engine noise so that it can be heard by a driver or observer of a vehicle. This not only improves the driving experience for the driver, but also assists the driver in determining whether there is a problem with the engine of the vehicle. The arrangement of a hollow spacer situated between two flexible membranes provides two volumes of fluids between the two membranes to be excited by pressure variations—a first volume of fluid enclosed within the spacer and a second volume of fluid external to the spacer. An advantage of this arrangement is that a varied range of sound frequencies can be provided by the sound bypass device. This results in a desirable sound output. The apparatus is also light and cost effective: this advantage is achieved through the use of lightweight materials and joining techniques, and through the use of planar and hollow components. The low weight and cost efficiency of the apparatus makes it advantageous for use in vehicles such as sports cars, for which weight and cost considerations are important.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A sound bypass device configured to transmit engine-generated sound pulses from an engine to an auditory environment whilst preventing the flow of gases to the auditory environment, the sound bypass device comprising:
a chamber enclosing an internal volume between an inlet of the chamber and an outlet of the chamber, the inlet of the chamber being configured to receive gases exiting or entering the engine of the vehicle and the outlet of the chamber being configured to transmit sound pulses to the auditory environment;
a first flexible membrane located within the chamber, the first flexible membrane being configured to transmit engine-generated sound pulses from the gases whilst preventing the movement of fluids from the inlet of the chamber to the outlet of the chamber;
a second flexible membrane that is separated from the first flexible membrane within the chamber; and
a hollow spacer coupled to the first flexible membrane at a first end of the spacer and to the second flexible membrane at a second end of the spacer to separate the first flexible membrane from the second flexible membrane, the hollow spacer enabling the transmission of sound pulses from the first membrane to the second membrane.

2. The sound bypass device of claim 1, wherein the hollow spacer encloses a volume of fluid between the first membrane and the second membrane such that secondary sound pulses can pass from the first flexible membrane to the second flexible membrane via the fluid.

3. The sound bypass device of claim 1, wherein the internal volume of the chamber comprises a length that extends between the inlet of the chamber and the outlet of the chamber and a cross-sectional area that is perpendicular to the length, wherein each of the first and second flexible membranes are located within the chamber such that they cover the cross-sectional area of the internal volume.

4. The sound bypass device of claim 1, wherein the hollow spacer has a length that extends between the first flexible membrane and the second flexible membrane and a cross-sectional area that is perpendicular to that length, and wherein the cross-sectional area of the spacer is smaller than the areas of the first and second flexible membranes.

5. The sound bypass device of claim 1, wherein the enclosed volume of the hollow spacer is cylindrical in shape.

6. The sound bypass device of claim 1, wherein the hollow spacer comprises a first flange for coupling to the first flexible membrane and a second flange for coupling to the second membrane.

7. The sound bypass device of claim 1, wherein the hollow spacer is coupled to the first and second flexible membranes by an adhesive substance.

8. The sound bypass device of claim 1, wherein the volume of fluid that is enclosed within the hollow spacer is a volume of air.

9. The sound bypass device of claim 1, wherein each of the first and second flexible membranes comprises a planar member that is connected to the internal volume of the chamber by a suspension mechanism.

10. The sound bypass device of claim 9, wherein each suspension mechanism comprises a rim with an undulating surface that surrounds its respective planar member.

11. The sound bypass device of claim 1, wherein each of the first and second flexible membranes comprises an inner surface that couples to the hollow spacer and an outer surface located on an opposing side of the respective membrane to the inner surface.

12. The sound bypass device of claim 1, wherein each of the first and second flexible membranes comprises:
a planar component defining the inner surface of the membrane and being coupled to the hollow spacer; and
a covering portion defining at least part of the outer surface of the membrane, the covering portion being coupled around the circumference of the planar component;
wherein, for each of the first and second membranes, the planar ring and the covering portion are constructed from materials of different elasticity.

13. The sound bypass device of claim 12, wherein each of the first and second flexible membranes comprises an inner surface that couples to the hollow spacer and an outer surface located on an opposing side of the respective membrane to the inner surface and the covering portion of each of the first and second membranes is located on the outer surface of its respective membrane.

14. The sound bypass device of claim 12, wherein the planar component of each of the first and second flexible membranes is constructed from a sheet of metal.

15. The sound bypass device of claim 1, wherein the internal volume of the chamber has a first portion that is located between the inlet of the chamber and the first membrane and a second portion that is located between the second membrane and the outlet, wherein the cross-sectional area of the first portion of the internal volume increases as it extends between the inlet and the first membrane.

16. The sound bypass device of claim 15, wherein the rate of increase of cross-sectional area of the first portion of the internal volume is constant as it extends between the inlet and the first membrane.

17. The sound bypass device of claim 15, wherein the internal volume of the chamber further comprises a third portion that extends between the first and second membranes.

18. The sound bypass device of claim 17, wherein the first flexible membrane is coupled to the chamber by a protrusion of the first flexible membrane that is located within a first cavity formed within the housing of the chamber.

19. The sound bypass device of claim 1, wherein the auditory environment is the cabin of the vehicle.

20. A vehicle comprising the sound bypass device of claim 1.
